(19) United States
(12) Patent Application Publication
(10) Pub. No.: US 2013/0243994 A1
(43) Pub. Date: Sep. 19, 2013

(54) PROTECTION FILM FOR LENS MODULE AND METHOD FOR MANUFACTURING SAME

(71) Applicants: SHU-SHENG PENG, Shenzhen City (CN); YONG LI, Shenzhen City (CN)

(72) Inventors: SHU-SHENG PENG, Shenzhen City (CN); YONG LI, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/534,263

(22) Filed: Jun. 27, 2012

(30) Foreign Application Priority Data
Mar. 15, 2012 (CN) 201210067660.2

(51) Int. Cl. C09J 7/02; B32B 38/04; B32B 37/02

(52) U.S. Cl. 428/78; 428/77; 156/250

(57) ABSTRACT

A protection film includes a base film, a layer of adhesive, and a partition film. The base film includes a main portion and a handle portion extending from a periphery of the main portion. The main portion and the handle portion include a pair of opposite first surfaces. The adhesive is uniformly coated on one of the first surfaces. The adhesive is continuously coated on the main portion and the handle portion. The partition film includes a pair of opposite second surfaces. One of the second surfaces is adhered to a portion of the adhesive coated on the handle portion.

### BACKGROUND

1. Technical Field

The present disclosure relates to protection films and, particularly, to a protection film for protecting a lens module and a method for manufacturing the protection film.

2. Description of Related Art

To protect a lens modules from being scratched during an assembly of the lens modules into electronic products such as cell phones or cameras, a protection film is employed. The protection film usually includes a generally circular main portion having an adhesive layer adhered to the lens module and a generally strip-shaped non-adhesive handle portion extending from the main portion for conveniently removing the protection film from the lens module. In use, the protection film needs to be removed from the lens module, and is removed by pulling the handle portion. However, as the handle portion is pulled, the adhesive layer is readily broken at a joint between the main portion and the handle portion. A part of adhesive layer may remain on the lens module, which contaminates the lens module. Therefore, it is desirable to provide a protection film and a method for manufacturing the protection film which can overcome the above-mentioned problems.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the views.

FIG. 1 is an exploded view of a protection film, according to an exemplary embodiment.

FIG. 2 is an assembled view of the protection film of FIG. 1.

FIG. 3 is a cross-sectional view of the protection film of FIG. 2, take along a line III-III.

FIG. 4 is a flowchart of a method for manufacturing a protection film, according to an exemplary embodiment.

FIG. 5 is schematic view of the manufacturing method of FIG. 4, which is in a first stage.

FIG. 6 is schematic view of the manufacturing method of FIG. 4, which is in a second stage.

FIG. 7 is schematic view of the manufacturing method of FIG. 4, which is in a third stage.

### DETAILED DESCRIPTION

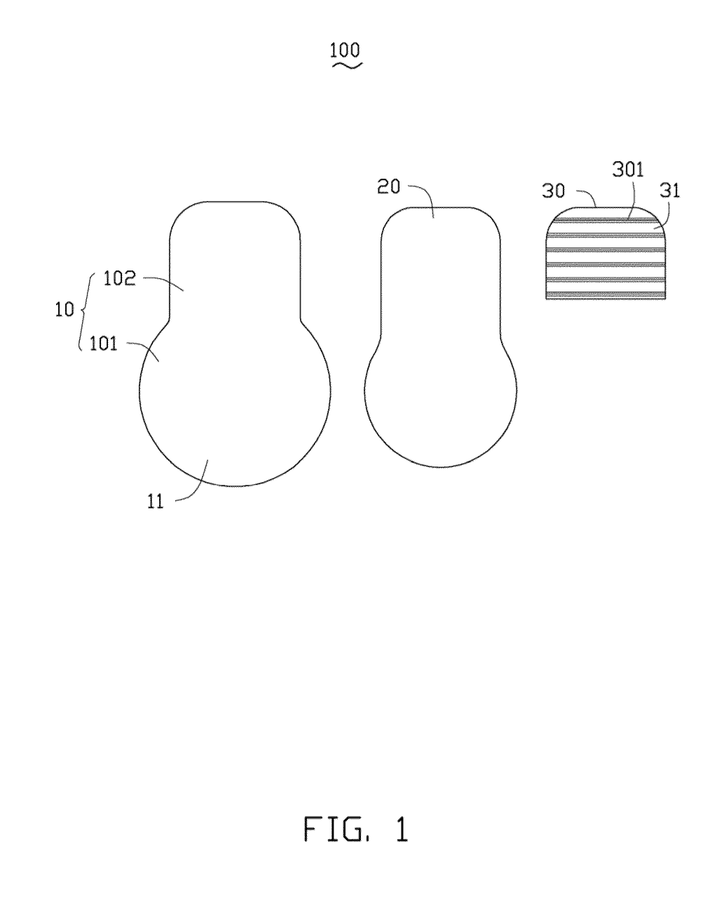

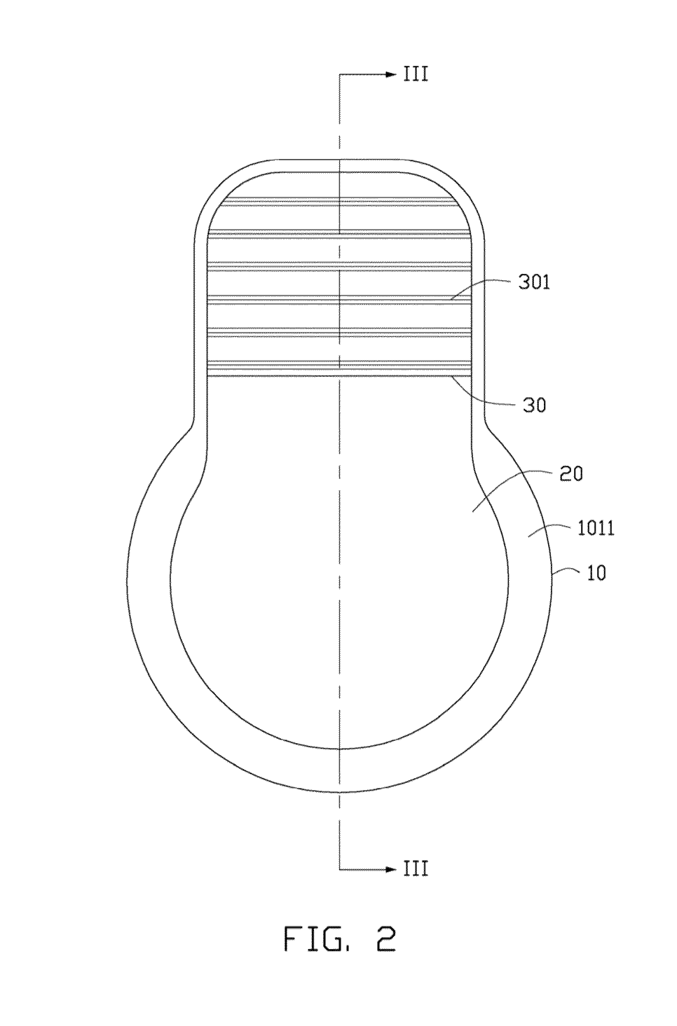

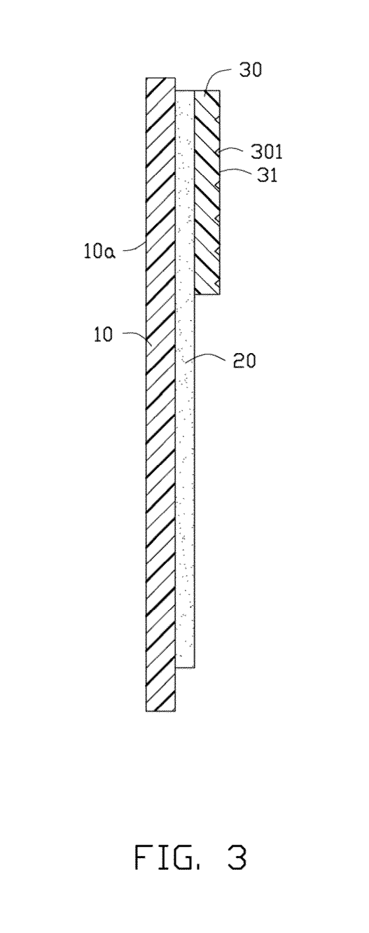

FIGS. 1 to 3 illustrate a protection film 100 in accordance with an exemplary embodiment for use to be adhered to an outer surface of a lens module (not shown), thus protecting the lens module from being scratched during the lens module is assembling. The protection film 100 includes a layer of base film 10, a layer of adhesive 20, and a layer of partition film 30.

The base film 10 is made of electrostatic absorption material, for example, polyethylene (PE) or polyethylene terephthalate (PET). In the embodiment, the base film 10 is a transparent film and is made of PET. The base film 10 includes a substantially circular main portion 101 and a substantially rectangular handle portion 102 extending from a periphery of the main portion 101. The main portion 101 and the handle portion 102 include a pair of opposite first surfaces 11.

The adhesive 20 are uniformly coated on one of the first surfaces 11 of the base film 10. In the embodiment, the adhesive 20 are continuously coated on the main portion 101 and the handle portion 102. The adhesive 20 is made from acrylic acid ester and unsaturated hydrocarbon. An area of the adhesive 20 is less than an area of each first surface 11, leaving a margin area 1011 surrounding the adhesive 20. The margin area 1011 is not coated with the adhesive 20 and formed on the main portion 101 and the handle portion 102.

The partition film 30 is also made of PET and includes a pair of opposite second surfaces 31. An area of each second surface 31 is greater than an area of the adhesive 20 coated on the handle portion 102. One of the second surfaces 31 is adhered to a portion of the adhesive 20 coated on the handle portion 102. The other second surface 31 faces away from the adhesive 20 and defines a plurality of grooves 301. The grooves 301 are uniformly distributed and parallel to each other.

During assembling the lens module to electronic products, the adhesive 20 coated on the main portion 101 is adhered to the lens module such that the main portion 101 can protect the lens module from being scratched. The partition film 30 can prevent the handle portion 102 from adhering to the lens module. After assembling, the handle portion 102 is clamped by a tool or fingers of an operator through pressing on the first surface 11 opposite to the adhesive 20 and the second surface 31 opposite to the adhesive 20, then the handle portion 102 is pulled such the adhesive 20 coated on the main portion 101 can be separated from the lens module.

In alternative embodiment, the main portion 101 and the handle portion 102 do not form the margin portion 1011. The adhesive 20 is completely coated on one of the first surface 11 of the main portion 101 and the handle portion 102.

In the embodiment, the adhesive 20 is continuously coated on the main portion 101 and the handle portion 102, namely a portion of the adhesive 20 coated on the main portion 101 is not separated from another portion of the adhesive 20 coated on the handle portion 102. Therefore, when pulling the handle portion 102, the adhesive 20 coating on the main portion 101 is prevented from leaving on the lens module.

In the embodiment, friction between the tool or the fingers of the operator and the second surface 31 opposite to the adhesive 20 increases when pulling the handle portion 102 because of the grooves 301. In other embodiment, the second surface 31 facing away from the adhesive 20 can be ground.

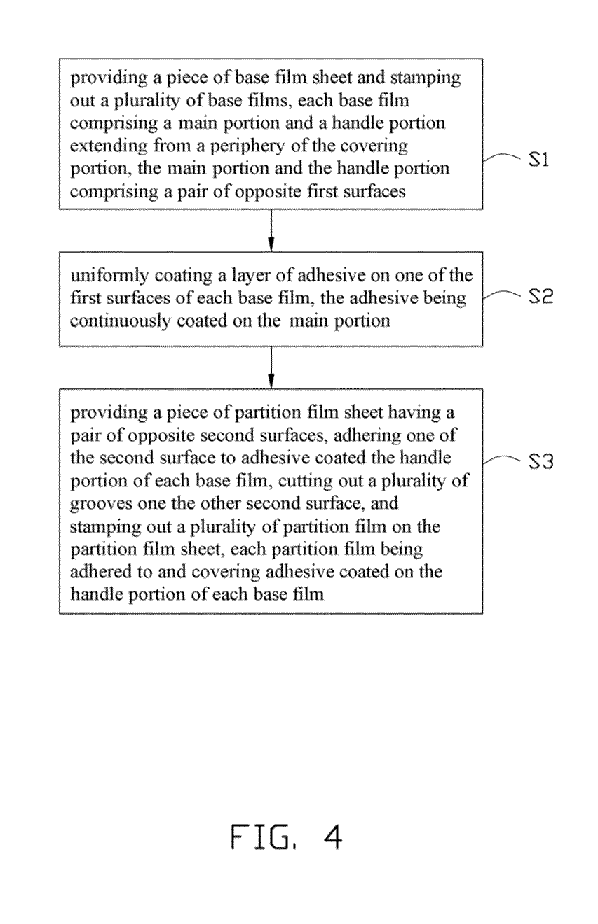

FIGS. 4 to 7 illustrate a manufacturing method for the protection film 100, in accordance with an exemplary embodiment. The manufacturing method includes the following steps:

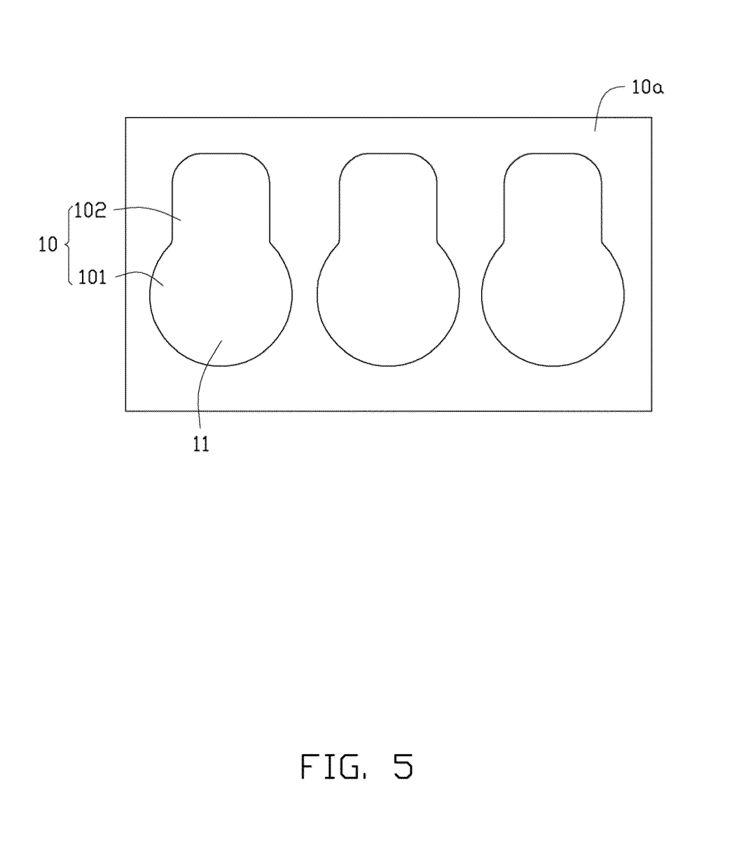

Referring to FIGS. 4 and 5, in step S1, providing a piece of base film sheet 10a and stamping out a plurality of base films 10 on the base film sheet 10a. The base film sheet 10a is substantially rectangular and made of PET. Each base film 10 includes a substantially circular main portion 101 and a substantially rectangular handle portion 102 extending from a periphery of the main portion 101. The main portion 101 and the handle portion 102 include a pair of opposite first surfaces 11.

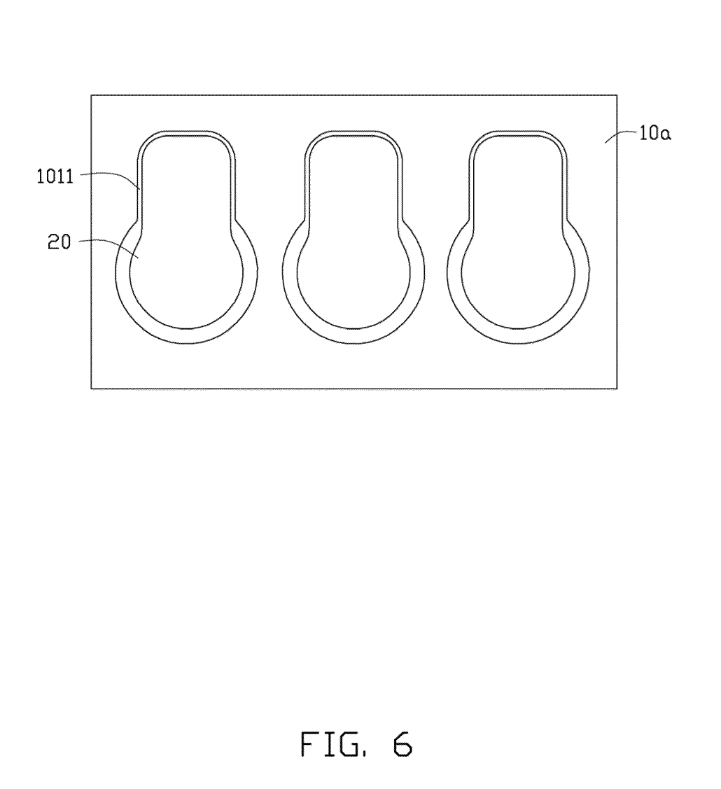

Referring to FIGS. 4 and 6, in step S2, uniformly coating a layer of adhesive 20 on one of the first surfaces 11 of each base film 10. The adhesive 20 are continuously coated on the main portion 101 and the handle portion 102. An area of the adhesive 20 is less than an area of each first surface 11, leaving a margin area 1011 surrounding the adhesive 20. The margin area 1011 is not coated with the adhesive 20 and formed on the main portion 101 and the handle portion 102. In alternative embodiments, the main portion 101 and the handle portion 102 do not form the margin portion 1011. The adhesive 20 is completely coated on the main portion 101 and the handle portion 102.

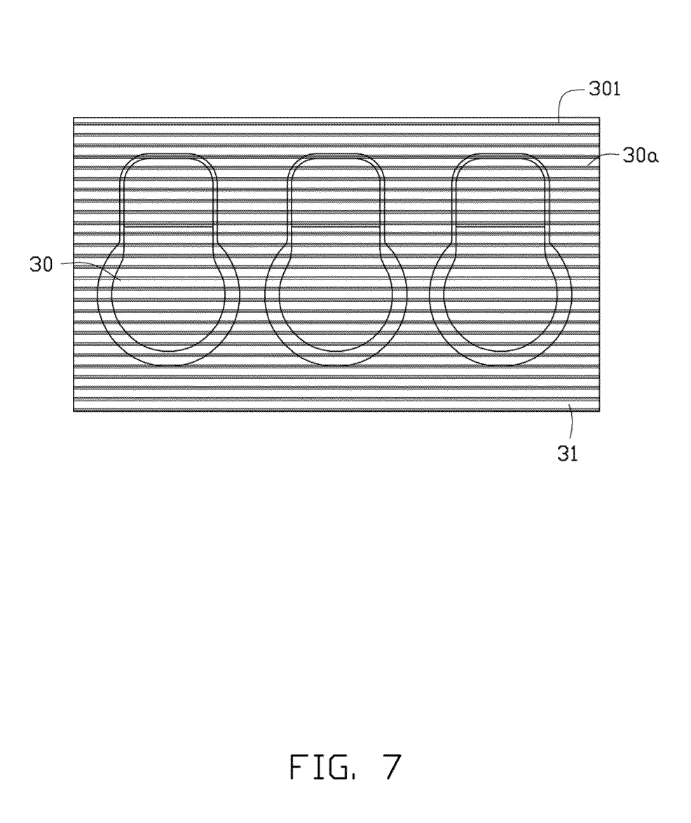

Referring to FIGS. 4 and 7, in step S3, providing a piece of partition film sheet 30a having a pair of opposite second surfaces 31, adhering one of the second surfaces 31 to the adhesive 20 coated on the handled portion 102 of each base film 10, cutting out a plurality of grooves 301 on the other second surface 31 facing away from the adhesive 20, and stamping out a plurality of partition film 30 on the partition film sheet 30a. The partition film sheet 30a is substantially rectangular, which corresponds to the base film sheet 10a in shape. Each partition film 30 is adhered to and covers a portion of the adhesive 20 coated on the handle portion 102 of each base film 10.

It will be understood that the above particular embodiments are shown and described by way of illustration only. The principles and the features of the present disclosure may be employed in various and numerous embodiment thereof without departing from the scope of the disclosure as claimed. The above-described embodiments illustrate the possible scope of the disclosure but do not restrict the scope of the disclosure.

1. A protection film for protecting a lens module, comprising:
a base film comprising a main portion and a handle portion extending from a periphery of the main portion, the main portion and the handle portion comprising a pair of opposite first surfaces;
a layer of adhesive uniformly coated on one of the first surfaces, the adhesive being continuously coated on the main portion and the handle portion; and
a partition film comprising a pair of opposite second surfaces, one of the second surface being adhered to a portion of the adhesive coated on the handle portion.

2. The protection film of claim 1, wherein an area of the adhesive is less than an area of each first surface, the main portion and the handle portion form a margin area surrounding the adhesive, the margin area is not coated with the adhesive.

3. The protection film of claim 1, wherein the main portion is substantially circular and the handle portion is substantially rectangular.

4. The protection film of claim 1, wherein the other second surface facing away from the adhesive defines a plurality of grooves.

5. The protection film of claim 4, wherein the grooves are uniformly distributed and parallel to each other.

6. The protection film of claim 1, wherein the other second surface facing away from the adhesive is ground.

7. The protection film of claim 1, wherein the base film and the partition film are made of polyethylene terephthalate.

8-12. (canceled)
